(19) United States
(12) Patent Application Publication
(10) Pub. No.: US 2014/0352665 A1
(43) Pub. Date: Dec. 4, 2014

(54) ENGINE APPARATUS

(71) Applicant: MIKUNI CORPORATION, Tokyo (JP)

(72) Inventor: Sho MORIYA, Kanagawa (JP)

(73) Assignee: MIKUNI CORPORATION, Tokyo (JP)

(21) Appl. No.: 14/285,763

(22) Filed: May 23, 2014

(30) Foreign Application Priority Data
May 28, 2013 (JP) 2013-111810

(51) Int. Cl. F02M 37/00

(52) U.S. Cl. CPC F02M 37/00
USPC 123/446

(57) ABSTRACT

Upon arranging a separator tank in a V bank formed between a pair of cylinders, an arrangement position thereof is set to be a position unsusceptible to an influence from an exterior. The separator tank in which a fuel pump that stores liquid fuel in an interior thereof and feeds the liquid fuel toward an injector is accommodated is arranged in the V bank formed between the pair of cylinders which is provided in an engine, and arranged immediately below an air cleaner.

### BACKGROUND OF THE INVENTION

1. Field of the Invention

The present invention relates to an engine apparatus, particularly to an engine apparatus including a fuel injection device that injects liquid fuel to an interior of each of a pair of cylinders arranged in a state where the cylinders are inclined with respect each other to form a V shape, and a liquid fuel storage tank in which a feed pump that feeds the liquid fuel toward the fuel injection device is accommodated.

2. Description of the Related Art

A V-type engine having a pair of cylinders inclined with respect to each other to form a V shape is already known. In a system for supplying liquid fuel to this V-type engine, in general, a sub tank serving as a fuel reservoir is installed in the vicinity of the engine. This sub tank is installed for the purpose of suppressing that the fuel is gasified and vapor is generated in a route from a fuel tank to a fuel injection device. Specifically speaking, the liquid fuel is separated into a gas and a liquid in the tank, and the fuel in a liquid state among the liquid fuel is pressure-fed toward the fuel injection device by a fuel pump installed in the tank.

The V-type engine is required to be downsized and compactified. For example, there is a V-type engine in which by effectually utilizing a space around the engine, devices forming an engine apparatus are installed in the space (for example, refer to Japanese Patent No. 4108721 and Unexamined Japanese Patent Application Publication No. 5-106527). Japanese Patent No. 4108721 discloses a configuration that a high pressure fuel system is arranged in a V bank formed between cylinder blocks. Unexamined Japanese Patent Application Publication No. 5-106527 discloses a configuration that a fuel supply unit in which a high pressure fuel system and an intake system are assembled is arranged in a V bank formed between right and left cylinder bodies. The configurations disclosed by the above two documents, compactification of the entire engine is realized.

By arranging the constituent devices of the engine apparatus in the V bank as described above, the compactification of the entire engine is realized, and the configuration that the above sub tank is arranged in the V bank is considered as a configuration example. Meanwhile, the sub tank is desirably arranged at a position preferable in relation with peripheral devices thereof. Specifically speaking, in Japanese Patent No. 4108721 and Unexamined Japanese Patent Application Publication No. 5-106527, since the sub tank arranged in the V bank is exposed to an exterior, the sub tank is susceptible to an influence from the exterior (such as an impact). Therefore, upon arranging the sub tank in the V bank, the sub tank is desirably placed at a position unsusceptible to the influence from the exterior (such as the impact). Further, device layout is expected to be set so as to obtain an effect other than the compactification of the engine.

### SUMMARY OF THE INVENTION

The present invention is achieved in consideration with the above problem, and an object thereof is to provide an engine apparatus in which upon arranging a liquid fuel storage tank between a pair of cylinders inclined with respect to each other to form a V shape, an arrangement position thereof is set to be a position unsusceptible to an influence from an exterior.

The above problem is solved by an engine apparatus of the present invention. Here, the engine apparatus is an engine apparatus including a pair of cylinders arranged in a state where the cylinders are inclined with respect to each other to form a V shape, a fuel injection device that injects liquid fuel to an interior of each of the pair of cylinders, a storage tank that stores the liquid fuel in an interior thereof, a fuel pump accommodated in the storage tank, the fuel pump that feeds the liquid fuel in the storage tank toward the fuel injection device, and an air cleaner that purifies the air to be taken into each of the pair of cylinders, wherein the storage tank is arranged in a space between the pair of cylinders, and arranged at a position on the lower side of the air cleaner.

With the above configuration, the storage tank is arranged in the space formed between the pair of cylinders, that is, in a V bank, and arranged at the position on the lower side of the air cleaner. With such a positional relationship, in addition to compactification of the engine apparatus, the storage tank becomes unsusceptible to an influence from an exterior (such an as impact from the exterior). Thereby, there is no need for sufficiently ensuring durability of the storage tank itself against the impact from the exterior, but durability required at a level for exerting a function of the storage tank is sufficient. As a result, manufacturing cost of the engine apparatus can be reduced. It should be noted that the above effect is particularly meaningful in a situation where the engine is exposed to the exterior.

The above engine preferably includes a throttle body in which a flow passage of the air to be taken into each of the pair of cylinders is formed in an interior thereof, and an exhaust mechanism including a part group for exhausting a fuel gas generated in each of the pair of cylinders to an exterior, and the storage tank is arranged in a space sandwiched between the throttle body and the exhaust mechanism.

With the above configuration, the storage tank is arranged between the throttle body and the exhaust mechanism. Thus, radiation heat from the exhaust mechanism is blocked by the storage tank, so that an increase in a temperature of the air flowing in the throttle body due to the radiation heat can be suppressed.

In the above engine apparatus, more preferably, a bottom wall of the storage tank includes a first inclined portion inclined along one of the pair of cylinders, and a second inclined portion placed adjacently to the first inclined portion and inclined along the other cylinder.

With the above configuration, the bottom wall of the storage tank is bent at the substantially same angle as an angle made by the pair of cylinders. Thus, the storage tank can be arranged in the V bank in a favorable settlement manner.

In the above engine apparatus, furthermore preferably, the fuel pump is attached in a posture that the fuel pump is inclined along the first inclined portion in the storage tank.

With the above configuration, the fuel pump is accommodated in the storage tank in an inclined state. Thus, in comparison to a case where the fuel pump is vertically placed, the entire height of the storage tank can be shortened. As a result, further compactification of the entire engine apparatus can be achieved.

It should be noted that when the storage tank has a housing having an opening in an end on the opposite side of the bottom wall, and a cover that covers the opening of the housing, and a length of the fuel pump in the direction along the first inclined portion is longer than a distance from the bottom wall to the opening in the housing, an effect of compactifying the engine apparatus is more effectually exerted.

The above engine apparatus further preferably includes a fuel inflow limiting mechanism that cancels an inflow of the liquid fuel to the storage tank at a time point when a liquid surface of the liquid fuel in the storage tank reaches a predetermined position, and in a state where the liquid surface reaches the predetermined position and the fuel inflow limiting mechanism cancels the inflow of the liquid fuel, a part of a pump main body in which a movable part is built in the fuel pump is placed on the upper side of the liquid surface.

With the above configuration, the part of the pump main body in which the movable part is built in the fuel pump is placed on the upper side of the controlled liquid surface of the liquid fuel. A temperature of the pump main body is increased in accordance with an operation of the movable part. Thus, the more a part of the pump main body soaked in the liquid fuel is extended, the more easily an increase in a temperature and gasification of the liquid fuel are progressed. Meanwhile, with the above configuration, the part of the pump main body is placed on the upper side of the controlled liquid surface. Thus, in comparison to a configuration that the entire pump main body is soaked in the liquid fuel, the increase in the temperature and the gasification of the liquid fuel can be suppressed.

In the above engine apparatus, favorably, the storage tank is a separator tank that separates the liquid fuel in a liquid state and the liquid fuel in a gasified state, and the separator tank is arranged immediately below the air cleaner.

With the above configuration, the separator tank arranged in the V bank becomes unsusceptible to the influence from the exterior. Particularly, since the separator tank is arranged immediately below the air cleaner, the influence from the exterior on the separator tank can be more effectively suppressed.

In the above engine apparatus, further favorably, the separator tank includes a fixing portion formed to protrude for fixing the separator tank at an arrangement position thereof, and the fixing portion is placed on the lower side of a ceiling surface of the separator tank.

With the above configuration, size of the separator tank itself can be furthermore reduced.

In the engine apparatus of the present invention, by arranging the storage tank in the space formed between the pair of cylinders, that is, in the V bank, and arranging the storage tank at the position on the lower side of the air cleaner, the engine apparatus is compactified and further, the storage tank becomes unsusceptible to the influence from the exterior. Thereby, there is no need for sufficiently ensuring the durability of the storage tank itself against the impact from the exterior. As a result, the manufacturing cost of the engine apparatus can be reduced.

In the engine apparatus of the present invention, by arranging the storage tank between the throttle body and the exhaust mechanism, the storage tank blocks the radiation heat from the exhaust mechanism, so that the increase in the temperature of the air in the throttle body due to the radiation heat can be suppressed.

### BRIEF DESCRIPTION OF THE DRAWINGS

FIG. 1 is a view showing arrangement layout of constituent devices in an engine apparatus according to the present invention, the view in which the engine apparatus is seen from the front side;

FIG. 2 is a view showing the arrangement layout of the constituent devices in the engine apparatus according to the present invention, the view in which the engine apparatus is seen from the upper side; and

FIG. 3 is a sectional view showing a configuration of an interior of a separator tank.

### DESCRIPTION OF THE PREFERRED EMBODIMENTS

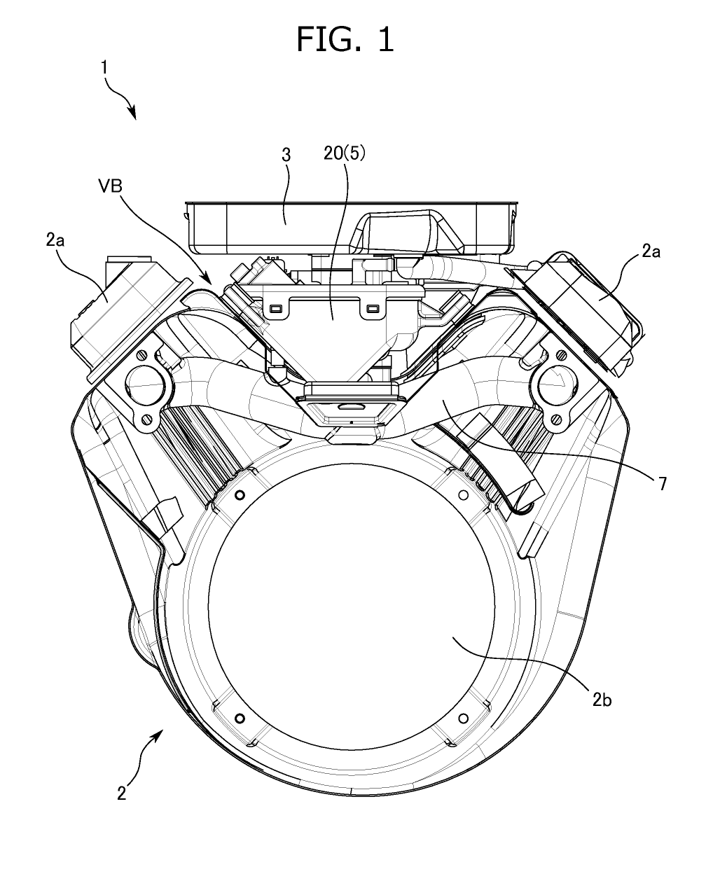

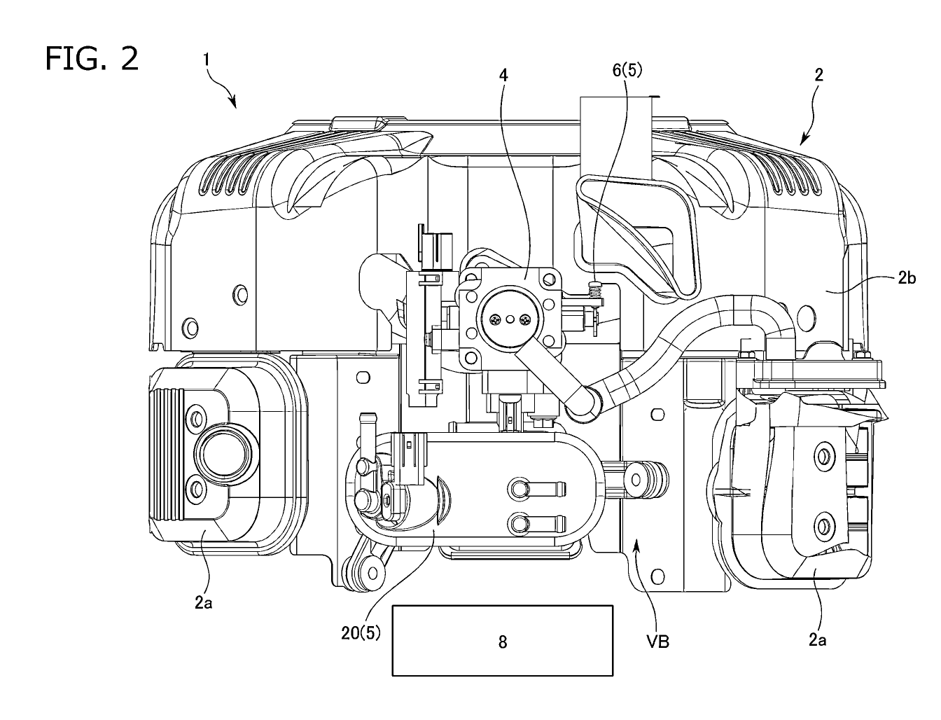

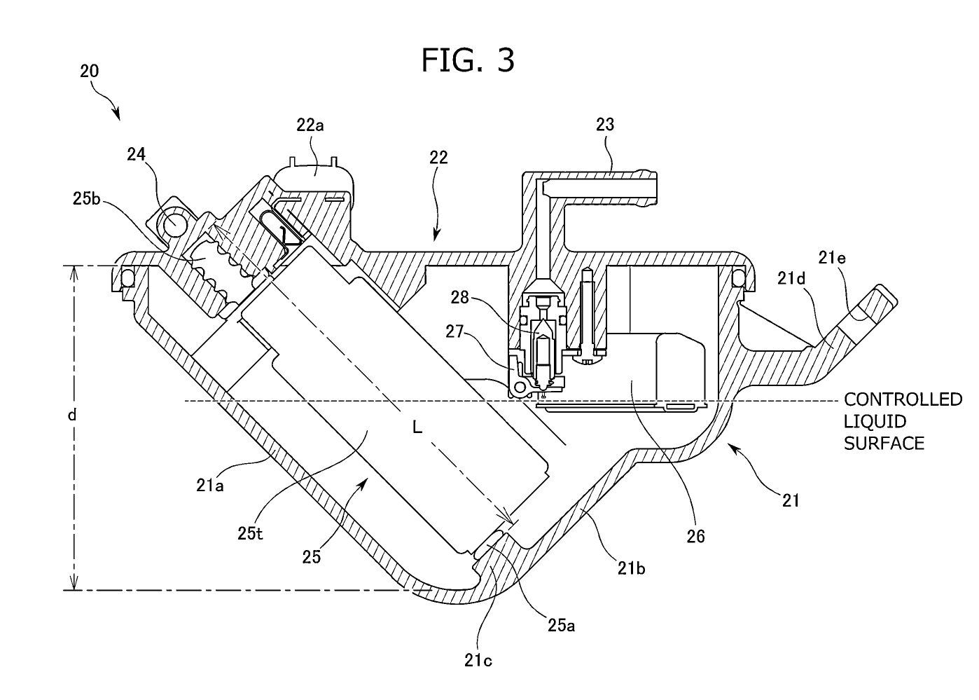

Hereinafter, a configuration example of an engine apparatus according to the present invention will be described with reference to FIGS. 1 to 3. FIGS. 1 and 2 are views showing arrangement layout of constituent devices in the engine apparatus according to the present invention. FIG. 1 is the view in which the engine apparatus is seen from the front side, and FIG. 2 is the view in which the engine apparatus is seen from the upper side. In FIG. 2, for the illustrative convenience, some device (specifically an exhaust mechanism) is depicted in a simplified manner, and a configuration that an air cleaner is removed is depicted in the figure. FIG. 3 is a sectional view showing a configuration of an interior of a separator tank.

It should be noted that an embodiment to be described below is not to limit the present invention but one example to facilitate understanding of the present invention. The present invention can be changed and improved without departing from the gist thereof, and the present invention includes equivalent items thereof as a matter of course.

Firstly, the entire configuration of an engine apparatus 1 according to the present invention will be described.

The engine apparatus 1 according to the present invention is formed by a V-type two-cylinder engine 2 and peripheral devices thereof as shown in FIGS. 1 and 2. The engine 2 is a generalized engine including a pair of right and left cylinders 2a as shown in FIG. 2. The pair of cylinders 2a corresponds to a pair of cylinders, and is arranged in a state where the cylinders are inclined with respect to each other to form a V shape when the engine 2 is seen from the front side. That is, the pair of cylinders 2a is attached to an upper part of the engine 2 in a state where inclination angles (bank angle) are equal to each other, and a V shape space, the so-called V bank VB is formed between the cylinders 2a.

It should be noted that in a crankcase 2b installed in a lower part in the cylinders 2a, a crankshaft (not shown) is arranged along the horizontal direction (direction passing through the paper plane of FIG. 1).

A high pressure fuel system, an intake system, and an exhaust system are connected to each of the cylinders 2a. The high pressure fuel system is a fuel supply device 5 formed for supplying high pressure liquid fuel into the cylinder 2a. The intake system is an intake mechanism including apart group for charging the air into the cylinder 2a. The exhaust system is an exhaust mechanism 8 including a part group for discharging a fuel gas generated in a combustion chamber of the cylinder 2a to an exterior.

The fuel supply device 5 will be described. The fuel supply device includes an injector 6 serving as a fuel injection device, a fuel pump 25, and a separator tank 20 serving as a storage tank as major devices. The injector 6 is a device that injects the liquid fuel to the combustion chamber (not shown) in the cylinder 2a, and a configuration thereof is known. It should be noted that in the present embodiment, as shown in FIG. 2, the injector 6 is attached to a side wall of a throttle body 4. However, an attachment position of the injector 6 is not limited to the position of FIG. 2 but may be other positions.

The fuel pump 25 is an injection pump that suctions and feeds the liquid fuel in the separator tank 20 to the injector 6. This fuel pump 25 includes for example a vertical and cylindrical pump main body 25t shown in FIG. 3, and a movable part is built in an interior thereof. Further, the fuel pump 25 according to the present embodiment is an in-tank type pump accommodated in the separator tank 20 as shown in FIG. 3. That is, when the liquid fuel in the separator tank 20 is suctioned into a suction port of the fuel pump 25 and then discharged from a discharge port of the same pump 25, the liquid fuel is taken out to an exterior of the tank from a hole 24 formed in the separator tank 20 and shown in FIG. 3, and fed to the injector 6. It should be noted that the suction port of the fuel pump 25 is placed, when seen from the vertical pump main body 25t, on the side of one end in the longitudinal direction thereof, and the discharge port is placed on the side of the other end in the longitudinal direction.

The separator tank 20 is a container that receives and stores the liquid fuel fed from a fuel tank (not shown) by a feed pump (not shown) in an interior thereof, and also separates the liquid fuel into a gas and a liquid. The separator tank has an outer shape formed in a downward triangle in a front view. As described above, the fuel pump 25 is accommodated in the separator tank 20, and the liquid fuel in the tank is suctioned into the fuel pump 25, then, discharged to the exterior of the tank, and supplied to the injector 6.

It should be noted that a structure and an arrangement position of the separator tank 20 will be described in detail later.

The intake mechanism will be described. The intake mechanism includes an air cleaner 3, the throttle body 4, and an intake manifold 7 as major devices. The air cleaner 3 is a device that purifies the air taken into each of the cylinders 2a, and has an outer shape formed in a substantial box. In the present embodiment, the air cleaner 3 is arranged at a position on the upper side of the engine 2, particularly at a position on the upper side of the V bank VB. As shown in FIG. 1, when the air cleaner 3 according to the present embodiment is arranged at the position on the upper side of the V bank VB, the air cleaner has a width (length in the right and left direction when the engine apparatus 1 is seen from the front side) substantially equal to an opening width of the V bank VB, and further has a depth (length in the direction passing through the paper plane in FIG. 1) slightly longer than that of the V bank VB. It should be noted that although the air cleaner 3 is fixed to the throttle body 4 and the engine 2 in the present embodiment, a part such as a bracket may be interposed between the air cleaner 3 and the engine 2.

The throttle body 4 is a device in which a flow passage of the air passing through the air cleaner 3 to be taken into each of the cylinders 2a is formed in an interior thereof, and includes a throttle valve (not shown) serving as an adjustment valve of an air flow rate at an intermediate position of the flow passage. As shown in FIG. 2, this throttle body 4 is fixed to a part of the upper part of the engine 2 placed on the far side of the pair of cylinders 2a. In the present embodiment, the air cleaner 3 is placed at a position one the upper side of the throttle body 4. In other words, the throttle body 4 is arranged in a state where an upper part thereof is covered by the air cleaner 3.

The intake manifold 7 is a manifold whose terminal end is connected to an intake port (not shown) of each of the cylinders 2a.

The exhaust mechanism 8 will be described. The exhaust mechanism includes an exhaust manifold, a catalyzer, and a silencer (all of those are not shown) as major devices. In the present embodiment, as shown in FIG. 2, the exhaust mechanism is arranged at a position on the near side of the engine 2, particularly at a position on the near side of the V bank VB.

Next, a structure of the separator tank 20 will be described with reference to FIG. 3.

The separator tank 20 is formed by combining a bowl shape housing 21, and a lid shape cover 22. The housing 21 forms a bottom wall and a side wall of the separator tank 20, and has an opening in an end on the opposite side of the bottom wall. The cover 22 is assembled to close the opening of the housing 21, and forms a ceiling wall of the separator tank 20. The separator tank 20 forms a storage space of the liquid fuel and accommodates the fuel pump 25 in the interior thereof.

The structure of the separator tank 20 will be described in more detail. A fuel receiving portion 23 shown in FIG. 3 is provided in an upper part of the cover 22, and the liquid fuel fed from the fuel tank flows into the separator tank 20 through the fuel receiving portion 23. The fuel receiving portion 23 is a tubular part of the cover 22 forming a flow passage of the liquid fuel.

In the separator tank 20, a fuel inflow limiting mechanism that cancels an inflow (receipt) of the liquid fuel at a time point when a liquid surface of the liquid fuel in the same tank 20 reaches a predetermined position is provided. This fuel inflow limiting mechanism is formed by a float 26 provided in the separator tank 20, a rotating body 27 in which the float 26 is attached to one end, and a needle valve 28 placed in the flow passage which is formed in the above fuel receiving portion 23, the needle valve to be opened and closed in accordance with a rotating action of the rotating body 27. With such a configuration, when the float 26 floating up on the liquid surface of the liquid fuel is moved upward by upward movement of the liquid surface, the rotating body 27 is rotated in conjunction with this, and further, the needle valve 28 is directed to a close position in accordance with the rotating action of the rotating body 27. When the liquid surface of the liquid fuel reaches the predetermined position (position shown by a broken line in FIG. 3), the needle valve 28 is placed at the close position. As a result, a receiving flow passage of the liquid fuel is blocked, so that the inflow of the liquid fuel to the separator tank 20 is cancelled.

Further, the separator tank 20 according to the present embodiment adopts a structure where the liquid fuel is easily accumulated in the suction port of the fuel pump 25 accommodated in the interior thereof. More specifically speaking, a bottom wall of the separator tank 20, that is, the bottom wall of the housing 21 is bent in a V shape at a center part in the width direction as shown in FIG. 3. In other words, a first inclined portion 21a and a second inclined portion 21b inclined with respect to each other to form a V shape are provided. The first inclined portion 21a and the second inclined portion 21b are adjacent to each other and serve as parts placed on the most bottom side of the bottom wall of the separator tank 20. An inclination angle of the first inclined portion 21a and an inclination angle of the second inclined portion 21b are substantially equal to each other.

In the interior space of the separator tank 20, the suction port of the liquid fuel provided in the fuel pump 25 is arranged in a region sandwiched between the first inclined portion 21a and the second inclined portion 21b in the above interior space. More strictly speaking, as shown in FIG. 3, the above suction port is arranged in the most bottom part of the interior space of the separator tank 20, that is, in the vicinity of a part where the first inclined portion 21a and the second inclined portion 21b cross each other.

As described above, a bottom surface of the separator tank 20 is bent in a V shape and the suction port of the fuel pump 25 is arranged in the vicinity of the bent part. Thus, in comparison to a case where the bottom surface of the tank is flat (flat with respect to the liquid surface of the liquid fuel), the liquid fuel is easily accumulated in the above suction port. By such an operation, even if the fuel becomes relatively insufficient, the fuel pump 25 can be maintained in a state where the liquid fuel is continuously suctioned from the suction port and the liquid fuel is fed.

Although not particularly shown in FIG. 3, in general, in the ceiling wall of the separator tank 20, an air vent for discharging the liquid fuel in a gasified state among the liquid fuel in the same tank 20 to the exterior of the tank is installed. In general, this air vent is installed in the vicinity of center of the separator tank 20 (center when the separator tank 20 is seen from the upper side). Meanwhile, an arrangement position of the fuel pump 25 in the separator tank 20 is a slightly offset position from the center of the separator tank 20 in order to avoid contact with the air vent. When the bottom surface of the tank is flat with such a configuration, a problem that the liquid fuel is not easily suctioned into the fuel pump 25 at the time of insufficiency of the fuel is particularly easily generated.

Meanwhile, when the suction port of the fuel pump 25 is arranged in the vicinity of the bent part on the bottom surface of the separator tank 20 as in the present embodiment, and even if the fuel pump 25 is arranged at the offset position from the center of the separator tank 20, the liquid fuel is easily accumulated in the suction port of the fuel pump 25, so that a state where the fuel pump 25 feeds the liquid fuel can be maintained even at the time of the insufficiency of the fuel. That is, an effect obtained by arranging the suction port of the fuel pump 25 in the vicinity of the bent part on the bottom surface of the separator tank 20 becomes more remarkable with the configuration that the air vent is installed in the separator tank 20.

Further, in the present embodiment, as shown in FIG. 3, the fuel pump 25 (strictly speaking, the pump main body 25t) is attached in a posture inclined along the first inclined portion 21a in the separator tank 20. Thereby, the separator tank 20 according to the present embodiment is slightly compactified in comparison to the conventional item in which the fuel pump 25 is attached perpendicularly to the liquid surface of the liquid fuel. Size of the fuel pump 25 is determined in accordance with a flow rate of the fuel to be fed per unit time. Therefore, upon compactifying the separator tank 20 while ensuring a predetermined feed amount, the configuration that the fuel pump 25 is attached while being inclined along the first inclined portion 21a is effectual and preferable.

More specifically speaking, when a length in the direction along the first inclined portion 21a, that is, the entire length of the fuel pump 25 is L, and a distance from the bottom wall to the opening in the housing 21, that is, the entire height of the housing 21 is d, L>d is established in the present embodiment. Under such a configuration, the configuration that the separator tank 20 is compactified by attaching the fuel pump 25 while inclining the fuel pump along the first inclined portion 21a is more effectually exerted. It should be noted that the entire height d of the housing 21 indicates a distance from a point placed on the most bottom side of the bottom surface of the housing 21 to a point placed on the uppermost end of the housing 21.

That is, when the fuel pump 25 is attached perpendicularly to the liquid surface of the liquid fuel, the relationship of L>d cannot be established but size of the separator tank 20 is increased in accordance with the entire length of the fuel pump 25. Meanwhile, with the configuration of the present embodiment, even in the relationship of L>d, the fuel pump 25 can be reliably accommodated in the separator tank 20. That is, when the fuel pump 25 that feeds the liquid fuel at the predetermined flow rate is accommodated in the separator tank 20, the size of the same tank 20 (strictly speaking, the distance d) can be more reduced.

It should be noted that as shown in FIG. 3, the fuel pump 25 according to the present embodiment is accommodated in a state where the fuel pump is sandwiched by the bottom wall of the housing 21 and the cover 22 in the separator tank 20. More specifically speaking, a convex shape fixing boss 21c that protrudes inward is provided in a part of the bottom wall of the housing 21 (strictly speaking, the second inclined portion 21b), the part being placed on the slightly upper side of the most bottom position. A slit (not shown) is formed in this fixing boss 21c, and the slit communicates with the fuel storage space in the separator tank 20 and reaches a top surface of the fixing boss 21c. Meanwhile, at a time point before the housing 21 and the cover 22 are combined, the fuel pump 25 is attached to the cover 22 in a part where a discharge line 25b of the liquid fuel is formed.

When the separator tank 20 is finished by combining the housing 21 and the cover 22, a bottom part of the fuel pump 25 is fixed to the above fixing boss 21c via an O ring 25a. On the inner side of a part of the fuel pump 25 in contact with the O ring 25a, the suction port of the liquid fuel is formed. When the bottom part of the fuel pump 25 is fixed to the fixing boss 21c, the above suction port communicates with the fuel storage space in the separator tank 20 via the slit formed in the fixing boss 21c.

Further, since the bottom wall of the separator tank 20 has the V shape bent part, rigidity in the vicinity of the bent part is improved, and as shown in FIG. 3, the above fixing boss 21c is provided in the vicinity of the bent part. As a result, strength around the fixing boss 21c is enhanced, so that a state where the fuel pump 25 is fixed by the fixing boss 21c can be favorably maintained.

In the present embodiment, as described above, when the liquid surface of the liquid fuel reaches the predetermined position, the float 26, the rotating body 27, and the needle valve 28 work together to cancel the inflow of the liquid fuel to the separator tank 20. When the liquid surface of the liquid fuel is placed at a position where the inflow to the separator tank 20 is cancelled, apart of, specifically an about ⅓ part on the discharge side of the pump main body 25t of the fuel pump 25 is placed on the upper side of the liquid surface. That is, in the present embodiment, the entire pump main body 25t is not soaked in the liquid fuel. Therefore, an increase in a temperature and gasification of the liquid fuel due to heat generated from the pump main body 25t at the time of actuating the pump can be suppressed.

Next, a positional relationship between the separator tank 20 and peripheral devices thereof, that is, device arrangement layout in the engine apparatus 1 will be described.

In general, a separator tank is arranged around a crankshaft in a V-type two-cylinder engine. Therefore, in the conventional engine, the separator tank is arranged for example at a position on the side of a crankcase.

Meanwhile, in the present embodiment, as shown in FIGS. 1 and 2, the separator tank 20 is arranged in the V bank VB in order to compactify the entire engine apparatus 1. Regarding the separator tank 20, the bottom wall is bent in a V shape as described above, and a bent angle thereof is the substantially same angle as an angle made by the pair of cylinders 2a. In other words, in a state where the separator tank 20 is arranged in the V bank VB, among the bottom wall of the separator tank 20, the first inclined portion 21a is inclined along one of the cylinders 2a, and the second inclined portion 21b adjacent to the first inclined portion 21a is inclined along the other cylinder 2a. It should be noted that a state where the inclined portions 21a, 21b are inclined along the corresponding cylinders 2a includes not only a mode where the inclination angles of the inclined portions 21a, 21b are the substantially same angles as the inclination angles (bank angle) of the corresponding cylinders 2a but also a mode where the above two inclination angles are more or less different from each other.

As describe above, in the present embodiment, since the bent angle of the bottom wall of the separator tank 20 and the angle made by the pair of cylinders 2a are the substantially same angles, the separator tank 20 can be arranged in the V bank VB in a favorable settlement manner. As described above, the size of the separator tank 20 itself is reduced. Thus, the separator tank 20 can be favorably settled in the V bank VB. Further, by compactification of the separator tank 20, other devices (such as the air cleaner 3 and the throttle body 4) are easily arranged around the V bank VB. That is, by the compactification of the separator tank 20, an outfitting property of the devices around the engine 2 is improved.

It should be noted that the separator tank 20 arranged in the V bank VB is fixed by engaging an engagement portion that protrudes from a member around the separator tank 20 (such as an outer wall of the cylinder 2a) with an engagement hole 21e formed in a protruding portion 21d that protrudes from an outer surface of the housing 21. That is, the above protruding portion 21d corresponds to a fixing portion provided in the housing 21 for fixing the separator tank 20 at the arrangement position thereof, and the separator tank 20 is fixed at the arrangement point by a so-called snap fit method. Further, in the present embodiment, the protruding portion 21d is placed on the lower side of a ceiling surface of the separator tank 20 (specifically, an upper surface of the cover 22) as shown in FIGS. 1 and 3. With such a configuration, the engine apparatus 1 is furthermore downsized in the present embodiment.

In the present embodiment, the above configuration is adopted, and the part protruding from the upper surface of the cover 22 in a state where the separator tank 20 is arranged in the V bank VB, for example, the fuel receiving portion 23 and the like are placed on the lower side of a predetermined position. The predetermined position indicates a part placed on the uppermost side in the cylinder 2a of the engine 2. Further, the part protruding on the upper surface of the cover 22 for receiving the liquid fuel fed from the fuel tank, and the part protruding for feeding the liquid fuel from the separator tank 20 toward the injector 6 by the fuel pump 25 extend in the direction substantially orthogonal to the up and down direction. As shown in FIG. 3, a connector 22a for supplying electric power from a power source (not shown) to the fuel pump 25 is provided in the cover 22. However, the pull-in direction of a power source cable connected to such a connector 22a is the horizontal direction.

With the above configuration, the separator tank 20 is furthermore downsized, so that the engine apparatus 1 can be effectively compactified.

In the present embodiment, as described above, for the purpose of compactifying the separator tank 20, the fuel pump 25 is attached while being inclined along the first inclined portion 21a in the same tank 20. In the present embodiment, additionally, in order to compactify the separator tank 20, size of the parts installed in the interior of the tank (such as the float 26), a positional relationship between the parts, an attachment method, an attachment posture, and the like are adjusted. One example will be described. Regarding a shape of the float 26, a float enlarged in the height direction of the separator tank 20 and spread in the horizontal direction (strictly speaking, in the depth direction that is the direction passing through the paper plane of FIG. 3) is adopted. In addition to this, in the present embodiment, the length of the fuel pump 25 is shorter than a length of the float 26 in the depth direction (direction passing through the paper plane of FIG. 3). Therefore, in the separator tank 20, a part in which the fuel pump 25 is installed in an interior thereof is narrower in the depth direction than a part in which the float 26 is installed in an interior thereof. Thereby, the separator tank 20 is furthermore downsized.

Further, in the present embodiment, as shown in FIG. 1, the air cleaner 3 is arranged on the upper side of the separator tank 20 which is arranged in the V bank VB. In other words, the separator tank 20 is placed immediately below the air cleaner 3, and arranged in the V bank VB in a state where an upper part thereof is covered by the air cleaner 3. More specifically speaking, in the air cleaner 3, a part covering the separator tank 20 is placed at a position on the slightly upper side of the uppermost position of the engine 2 (strictly speaking, the uppermost position of the cylinder 2a).

By the positional relationship as described above, the separator tank 20 becomes unsusceptible to an influence from the exterior (such as an impact from the exterior). Thereby, durability of the separator tank 20 itself at a level required for exerting a function of the same tank 20 is sufficient, so that there is no need for durability at a relatively high level (durability against the impact from the exterior). Therefore, regarding the separator tank 20, a material can be more inexpensive and thickness of the wall can be thinner. As a result, manufacturing cost of the engine apparatus 1 can be reduced.

It should be noted that the above effect becomes particularly meaningful in a situation where the engine 2 is exposed to the exterior, that is, in a situation where the impact from the exterior is easily exerted on the devices around the engine 2.

Further, as shown in FIG. 2, in a state where the separator tank 20 is arranged in the V bank VB, the throttle body 4 and the exhaust mechanism 8 are placed on the opposite sides from each other with respect to the separator tank 20. In other words, by being arranged in the V bank VB, the separator tank 20 is arranged in a space sandwiched between the throttle body 4 and the exhaust mechanism 8.

As described above, since the separator tank 20 is arranged between the throttle body 4 and the exhaust mechanism 8, radiation heat from the exhaust mechanism 8 is blocked by the separator tank 20, so that an increase in a temperature of the air flowing in the throttle body 4 (intake air temperature) due to the radiation heat can be suppressed.

Meanwhile, since the separator tank 20 is arranged between the throttle body 4 and the exhaust mechanism 8, the separator tank is susceptible to the radiation heat from the exhaust mechanism 8, and the separator tank is arranged in the V bank VB where an atmospheric temperature is relatively high. Therefore, a heat transfer amount to the liquid fuel in the separator tank 20 becomes relatively large. Thus, an effect of suppressing the increase in the temperature and the gasification of the liquid fuel due to heat generated from the pump main body 25t by placing a part of the pump main body 25t of the fuel pump 25 on the upper side of the controlled liquid surface of the liquid fuel becomes more meaningful. It should be noted that for more effectively suppressing the increase in the temperature of the liquid fuel, a measure of increasing a feed amount of the liquid fuel from the fuel tank to the separator tank 20 or the like may be implemented.

1. An engine apparatus comprising:
a pair of cylinders arranged in a state where the cylinders are inclined with respect to each other to form a V shape;
a fuel injection device that injects liquid fuel to an interior of each of the pair of cylinders;
a storage tank that stores the liquid fuel in an interior thereof;
a fuel pump accommodated in the storage tank, the fuel pump that feeds the liquid fuel in the storage tank toward the fuel injection device; and
an air cleaner that purifies the air to be taken into each of the pair of cylinders,
wherein the storage tank is arranged in a space between the pair of cylinders, and arranged at a position on the lower side of the air cleaner.

2. The engine apparatus according to claim 1, further comprising:
a throttle body in which a flow passage of the air to be taken into each of the pair of cylinders is formed in an interior thereof; and
an exhaust mechanism including a part group for exhausting a fuel gas generated in each of the pair of cylinders to an exterior,
wherein the storage tank is arranged in a space sandwiched between the throttle body and the exhaust mechanism.

3. The engine apparatus according to claim 1, wherein a bottom wall of the storage tank includes a first inclined portion inclined along one of the pair of cylinders, and a second inclined portion placed adjacently to the first inclined portion and inclined along the other cylinder.

4. The engine apparatus according to claim 3, wherein the fuel pump is attached in a posture that the fuel pump is inclined along the first inclined portion in the storage tank.

5. The engine apparatus according to claim 4,
wherein the storage tank has a housing having an opening in an end on the opposite side of the bottom wall, and a cover that covers the opening of the housing, and
a length of the fuel pump in the direction along the first inclined portion is longer than a distance from the bottom wall to the opening in the housing.

6. The engine apparatus according to claim 4, further comprising:
a fuel inflow limiting mechanism that cancels an inflow of the liquid fuel to the storage tank at a time point when a liquid surface of the liquid fuel in the storage tank reaches a predetermined position,
wherein in a state where the liquid surface reaches the predetermined position and the fuel inflow limiting mechanism cancels the inflow of the liquid fuel, a part of a pump main body in which a movable part is built in the fuel pump is placed on the upper side of the liquid surface.

7. The engine apparatus according to claim 1,
wherein the storage tank is a separator tank that separates the liquid fuel in a liquid state and the liquid fuel in a gasified state, and
the separator tank is arranged immediately below the air cleaner.

8. The engine apparatus according to claim 7,
wherein the separator tank includes a fixing portion formed to protrude for fixing the separator tank at an arrangement position thereof, and
the fixing portion is placed on the lower side of a ceiling surface of the separator tank.

9. The engine apparatus according to claim 2, wherein a bottom wall of the storage tank includes a first inclined portion inclined along one of the pair of cylinders, and a second inclined portion placed adjacently to the first inclined portion and inclined along the other cylinder.

10. The engine apparatus according to claim 5, further comprising:
a fuel inflow limiting mechanism that cancels an inflow of the liquid fuel to the storage tank at a time point when a liquid surface of the liquid fuel in the storage tank reaches a predetermined position,
wherein in a state where the liquid surface reaches the predetermined position and the fuel inflow limiting mechanism cancels the inflow of the liquid fuel, a part of a pump main body in which a movable part is built in the fuel pump is placed on the upper side of the liquid surface.

11. The engine apparatus according to claim 2,
wherein the storage tank is a separator tank that separates the liquid fuel in a liquid state and the liquid fuel in a gasified state, and
the separator tank is arranged immediately below the air cleaner.

12. The engine apparatus according to claim 3,
wherein the storage tank is a separator tank that separates the liquid fuel in a liquid state and the liquid fuel in a gasified state, and
the separator tank is arranged immediately below the air cleaner.

13. The engine apparatus according to claim 4,
wherein the storage tank is a separator tank that separates the liquid fuel in a liquid state and the liquid fuel in a gasified state, and
the separator tank is arranged immediately below the air cleaner.

14. The engine apparatus according to claim 5,
wherein the storage tank is a separator tank that separates the liquid fuel in a liquid state and the liquid fuel in a gasified state, and
the separator tank is arranged immediately below the air cleaner.

15. The engine apparatus according to claim 6,
wherein the storage tank is a separator tank that separates the liquid fuel in a liquid state and the liquid fuel in a gasified state, and
the separator tank is arranged immediately below the air cleaner.

16. The engine apparatus according to claim 9,
wherein the storage tank is a separator tank that separates the liquid fuel in a liquid state and the liquid fuel in a gasified state, and
the separator tank is arranged immediately below the air cleaner.

17. The engine apparatus according to claim 10,
wherein the storage tank is a separator tank that separates the liquid fuel in a liquid state and the liquid fuel in a gasified state, and
the separator tank is arranged immediately below the air cleaner.
